(19) United States
(12) Patent Application Publication
(10) Pub. No.: US 2001/0052454 A1
(43) Pub. Date: Dec. 20, 2001

(54) Distillation apparatus for water purifiers

(76) Inventor: Oi-Seong Kim, Incheon-city (KR)

Correspondence Address: Striker, Striker & Stenby, 103 East Neck Road, Huntington, NY, 11743, US

(21) Appl. No.: 09/867,219

(22) Filed: May 29, 2001

(30) Foreign Application Priority Data
Jun. 14, 2000 (KR) 2000-16890

(51) Int. Cl. B01D 3/02; C02F 1/04

(52) U.S. Cl. 202/176; 202/185.1; 203/10; 203/22; 203/DIG. 8

(57) ABSTRACT

Disclosed herewith is a distillation apparatus for water purifiers. The distillation apparatus includes a purifier body, a boiler, a condensing coil and a water storage tank that are sequentially connected to each other. The front portion of the condensing coil is extended through a preheating tube comprised of a heat chamber, an inlet and an outlet. The inlet of the preheating tube and the purifier body is connected by a first purified water supply line. The outlet of the preheating tube and the boiler is connected by a second purified water supply line.

### BACKGROUND OF THE INVENTION

1. Field of the Invention

The present invention relates generally to a distillation apparatus for water purifiers that is used to distill natural water into potable water in water purifiers.

2. Description of the Prior Art

As illustrated in FIG. 3, a conventional distillation apparatus for water purifiers is operated in such a way that water having been purified in a purifier body 1 is heated into steam in a boiler 2, the steam is supplied to and liquefied into distilled water in a condensing coil 3, and the liquefied water is stored in a storage tank 4 and stays ready for dispensation.

In the conventional distillation apparatus for water purifiers, water of a relatively low temperature supplied from the purifier body 1 is heated into steam in the boiler 2 and the steam is supplied into the condensing coil 3, so the productivity of steam is relatively low and energy consumption is relatively great. Additionally, a large amount of supplementary water of a relatively low temperature is supplied from the purifier body 1 to the boiler 2 at one time, so the temperature of the boiler 2 is abruptly decreased and the temperature of water in the boiler 2 is frequently changed, thereby shortening the life span of heating means in the boiler 2.

This inventor has come to know that the shortcomings of the conventional art can be overcome by preheating water purified in the purifier body using heat discharged from a condensing coil of a relatively high temperature and, thereafter, supplying it to a boiler, and has accomplished this in the present invention.

### SUMMARY OF THE INVENTION

Accordingly, the present invention has been made keeping in mind the above problems occurring in the prior art, and an object of the present invention is to provide a distillation apparatus for water purifiers, which is capable of preheating purified water using heat discharged from its condensing coil through which steam passes and, thereafter, supplying the preheated water to its boiler.

In order to accomplish the above object, the present invention provides a distillation apparatus for water purifiers, comprising: a purifier body, a boiler, a condensing coil and a water storage tank that are sequentially connected to each other; wherein the front portion of the condensing coil is extended through a preheating tube comprised of a heat chamber, an inlet and an outlet, the inlet of the preheating tube and the purifier body is connected by a first purified water supply line, and the outlet of the preheating tube and the boiler is connected by a second purified water supply line.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing a distillation apparatus in accordance with the present invention;

FIG. 2 is a detailed, partial cross-section of a preheating tube of FIG. 1; and

FIG. 3 is a schematic diagram of a conventional distillation apparatus for water purifiers.

### DESCRIPTION OF THE PREFERRED EMBODIMENTS

Reference now should be made to the drawings, in which the same reference numerals are used throughout the different drawings to designate the same or similar components.

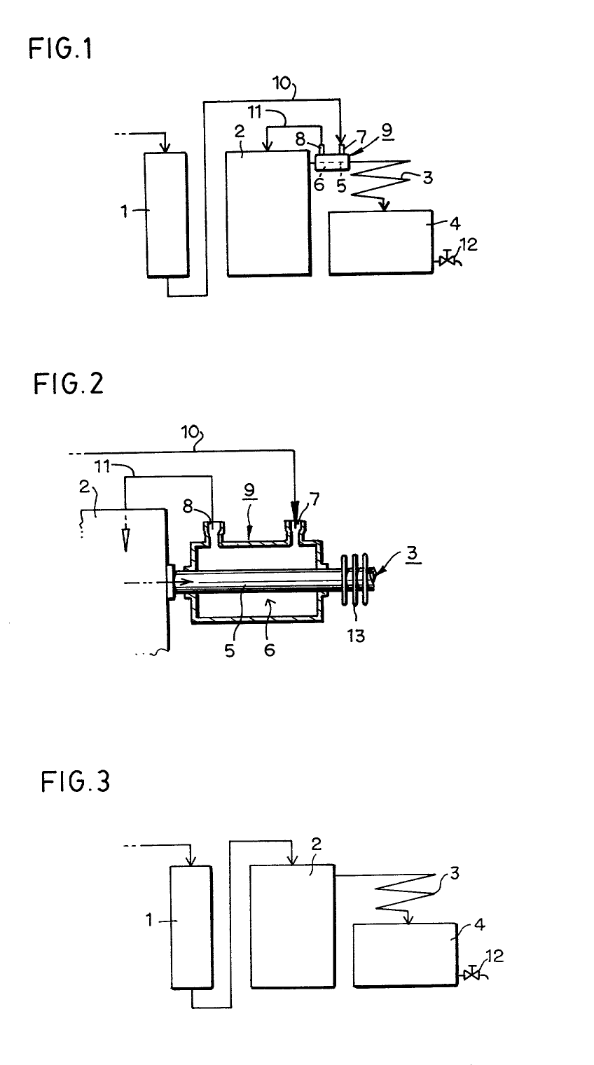

As illustrated in FIGS. 1 and 2, a distillation apparatus for water purifiers in accordance with the present invention is basically comprised of a purifier body 1, a boiler 2, a condensing coil 3 and a water storage tank 4, which are sequentially connected to each other. The front portion 5 of said condensing coil 3 is extended through a preheating tube 9 that is comprised of a heat chamber 6, an inlet 7 and an outlet 8. The inlet 6 of the preheating tube 9 and the purifier body 1 is connected by a first purified water supply line 10, and the outlet 8 of the preheating tube 6 and the boiler 2 is connected by a second purified water supply line 11.

In the basic construction of the distillation apparatus for water purifiers, water having been purified through the purifier body 1 is heated into steam in the boiler 2, the steam is supplied into and liquefied into distilled water in the condensing coil 3, and the liquefied water is stored in the storage tank 4 and stays ready for dispensation.

In accordance with the present invention, the preheating tube 9 is situated around the front portion of the condensing coil 3 and the temperature of the front portion of the condensing coil 3 is relatively high, so water, which has a relatively low temperature, which has been purified in the purifying body 1 and which is supplied to the boiler 2, can be preheated to a relatively high temperature in the preheating chamber 6 of the preheating tube 9 before flowing into the boiler 2.

In the preheating tube 9, its outlet 8 is preferably situated nearer to the boiler 2 than its inlet 7. The reason for this is that the temperature of the front portion of the condensing coil 3 is relatively high, the length of the second purified water supply line 11 can be reduced, and the preheating effect can be maximized by the prevention of the cooling of the preheated water during supply to the boiler 2.

Reference numerals 12 and 13 designate a distilled water discharge faucet and heat dissipation fins, respectively.

Water having been purified in the water purifier 1 is supplied through the first purified water supply line 10 to the inlet 7 of the preheating tube 9. The supplied water is preheated in the preheating tube 9 by heat discharged from the front portion 5 of the condensing coil 3 through which steam of relatively high temperature passes. The water preheated in the preheating tube 9 is supplied to the boiler 2 through the outlet 8 of the preheating tube 9 and the second distilled water supply line 11. In the boiler 2, the preheated water is heated into steam by means of the heating means of the boiler 2. The steam is liquefied into distilled water while passing through the condensing coil 3.

In other words, the preheating tube 9 of the distillation apparatus for water purifiers preheats purified water by heat discharged from the condensing coil 3 and supplies the preheated water to the boiler 2, so the thermal efficiency of the boiler 2 is improved and the steam passing through the condensing coil 3 is cooled rapidly, thereby improving the productivity of the distilled water.

As described above, the present invention provides a distillation apparatus for water purifiers, in which water is preheated by heat discharged from the condensing coil 3 through which steam of relatively high temperature passes and supplied to the boiler 2, and steam supplied from the boiler 2 to the condensing coil 3 is cooled rapidly, thereby obtaining distilled water of 41 liters using power consumption of 1,000 watt.

Accordingly, the distillation apparatus of the present invention is capable of reducing power consumption and the production amount of distilled water is increased. Additionally, the life span of the heating means of the distillation apparatus can be lengthened by the decrease of the load of the heating means of the boiler 2, so the maintenance costs of the boiler 2 can be curtailed. Further, the added structure of the distillation apparatus is simple, so the structure can be applied to various conventional distillation apparatuses.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A distillation apparatus for water purifiers, comprising:
a purifier body, a boiler, a condensing coil and a water storage tank that are sequentially connected to each other;
wherein the front portion of said condensing coil is extended through a preheating tube comprised of a heat chamber, an inlet and an outlet, said inlet of the preheating tube and said purifier body is connected by a first purified water supply line, and said outlet of the preheating tube and said boiler is connected by a second purified water supply line.
